(19) United States
(12) Patent Application Publication
(10) Pub. No.: US 2024/0408423 A1
(43) Pub. Date: Dec. 12, 2024

(54) POLE CLIMBING FALL RESTRICTION ASSEMBLY

(71) Applicant: BUCKINGHAM MANUFACTURING COMPANY, INC., Binghamton, NY (US)

(72) Inventors: Kevin Truesdell, Binghamton, NY (US); Jesse Taylor, Rileyville, VA (US)

(73) Assignee: BUCKINGHAM MANUFACTURING COMPANY, INC., Binghamton, NY (US)

(21) Appl. No.: 18/737,397

(22) Filed: Jun. 7, 2024

Related U.S. Application Data
(60) Provisional application No. 63/506,706, filed on Jun. 7, 2023.

(51) Int. Cl. A62B 35/00; F16D 63/00; F16G 11/00

(52) U.S. Cl. CPC A62B 35/0068; A62B 35/0075; F16D 63/006; F16D 63/008; F16G 11/00

(57) ABSTRACT

A fall restriction assembly for climbing wooden poles contains an outer strap adapted to wrap around the pole and an inner strap or lanyard that connects to both the outer strap and the user's body belt/harness. A narrow nose D-ring that restrains the connected component from relative motion and a cam assembly that engages robustly with the pole being climbed and has a handle for better ergonomics by the climber is also included.

### CROSS-REFERENCE TO RELATED APPLICATIONS

This invention claims priority to U.S. Provisional Patent Application No. 63/506,706 filed on Jun. 7, 2023, and entitled “Pole climbing fall restriction assembly” the entirety of which is incorporated herein.

### BACKGROUND OF THE INVENTION

### 1. Field of the Invention

The present invention relates generally to pole climbing equipment, and more specifically, to assemblies that assist in preventing a person from falling while ascending or descending a pole.

### 2. Description of the Related Art

Conventional pole climbing fall restriction assemblies are well known in the art. See, e.g., U.S. Pat. Nos. 6,752,242, 8,544,603, and 10,207,151. The assemblies typically comprise an outer strap adapted to wrap around the pole and an inner strap or lanyard that connects to both the outer strap and the user's body belt/harness. Portions of the assembly wrap around the front of the pole nearest the user, with the adjustment hardware adjusting the effective length of the outer and inner strap/lanyard. When a user begins ascending or descending a pole, he or she can grab a hold of the strap near one end, while making any necessary adjustments to the effective length of the straps with the other hand. When actually ascending or descending, the user can hold the ends of the straps or hardware and move them up or down while hitchhiking up or down the pole.

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Background Section and/or throughout the application, the descriptions/disclosures of which are all hereby incorporated by reference into this document in their respective entirety (ies).

### BRIEF SUMMARY OF THE INVENTION

The inventors of the present disclosure recognize that there are problems and limitations with conventional fall restriction assembly devices. For example, such devices do not provide a rotational constraint of motion on a D-ring and do not keep the cam assembly perpendicular to the pole, making climbing less safe and secure. Thus, there is a need for an improved pole climbing fall restriction assembly that provides for easier initial connections, and tighter and stronger working connections.

It is therefore a principal object and advantage of the present invention to provide a pole climbing fall restriction assembly that eliminates one or more of the problems/issues associated with conventional products. A particular non-limiting goal of the utilization of the embodiments and implementations herein is to provide a pole climbing fall restriction assembly that can include the following-a nose D-ring that has a large opening that is easy to connect to/disconnect from and which leads to a narrowed “nose” section. A first end of a connector (e.g., Roto Snap, snaphook or D-shaped carabineer) can attach to the large opening of the nose D-ring and can be pulled into connection with the narrowed nose section by force applied to a webbing or rope attached to a second end of the connector (e.g., when a user puts their weight into the assembly giving the connection rigidity to make moving the assembly up and down the pole when ascending and descending easier). One side of the connector can include a latch that can be biased to close and a second side that includes protruded serrations on the outside surface to catch and hold steady on a pole. A cam assembly is also provided and includes stopping teeth formed in the frame that is structured and configured to grip the pole (e.g., in the event of a drop but are designed to allow the user to still move around the pole). The eye of the cam assembly has been elongated (as compared to certain conventional cam assemblies-see, e.g., cam assembly described and illustrated in US 20190022465), to allow the inner strap or rope to move through when the full assembly is properly adjusted to the pole. Further, stand offs can be positioned on the back of the cam assembly to keep the cam assembly positioned perpendicular to the pole and keep the inner rope/strap from binding against the pole. The cam assembly can further comprise an ergonomic handle for adjusting the cam. A metal insert can also be incorporated on the first end of the inner rope/strap (attached with a keeper or incorporated into the tail of the inner strap/rope) to allow the first end of the rope to be stored on a magnetic add on pouch.

### BRIEF DESCRIPTION OF THE DRAWINGS

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments.

Reference is now made briefly to the accompanying drawings, in which:

FIG. 1 is a perspective view of the pole climbing fall restriction assembly according to an aspect of the present disclosure.

FIG. 1A is an alternate view of the assembly of FIG. 1 according to an aspect of the present disclosure.

FIG. 2 is an enlarged view of a “D” ring assembly and connector forming part of the fall restriction device of FIG. 1 according to an aspect of the present disclosure.

FIG. 3 is an enlarged view of an embodiment of the “D” ring according to an aspect of the present disclosure.

FIG. 4 is a perspective view of the pole climbing fall restriction assembly shown in use on a pole according to an aspect of the present disclosure.

FIG. 5 is an enlarged view of the embodiment of the “D” ring assembly and connector shown in use on a pole according to an aspect of the present disclosure.

FIG. 6 is another perspective view of the pole climbing fall restriction assembly shown in use on a pole according to an aspect of the present disclosure.

FIG. 7 is a perspective view of the cam assembly shown in use on a pole according to an aspect of the present disclosure.

FIG. 8 is a perspective view of the cam assembly forming part of the fall restriction device according to an aspect of the present disclosure.

FIG. 9 is a perspective view of the “D” ring according to an aspect of the present disclosure.

FIG. 10 is a perspective view of the cam according to an aspect of the present disclosure.

FIG. 11 is a top plan view of the cam according to an aspect of the present disclosure.

FIG. 12 is a perspective view of the cam assembly according to an aspect of the present disclosure.

FIG. 13 is a perspective view of the rope forming part of the fall restriction device according to an aspect of the present disclosure.

FIG. 14 is another perspective view of the rope forming part of the fall restriction device according to an aspect of the present disclosure.

FIG. 15 is a perspective view of the pole climbing fall restriction assembly according to an alternative embodiment of the present disclosure.

FIG. 16 is a perspective view of the cam assembly according to an alternative embodiment of the present disclosure.

FIG. 17 is another perspective view of the cam assembly according to an alternative embodiment of the present disclosure.

FIG. 18 is another perspective view of the cam assembly according to an alternative of the present disclosure.

FIG. 19 is an enlarged view of the “D” ring according to an alternative embodiment of the present disclosure.

FIG. 20 is an enlarged view of the “D” ring shown in use on a pole according to an alternative embodiment of the present disclosure.

FIG. 21 is a perspective view of the cam assembly shown in use on a pole according to an alternative embodiment of the present disclosure.

FIG. 22 is a perspective view of the cam assembly and handle shown in use on a pole according to an alternative embodiment of the present disclosure.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

While embodiments of the present invention have been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements. If elements are shown in a particular Figure discussed below are not specifically identified with respect to that Figure, the elements should be sufficiently identified with respect to at least one other Figure.

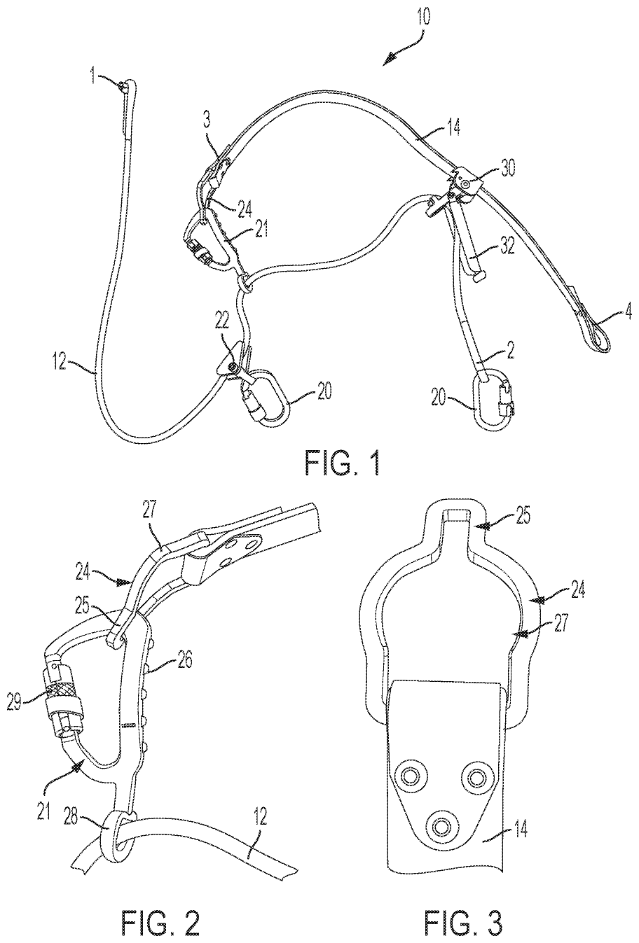

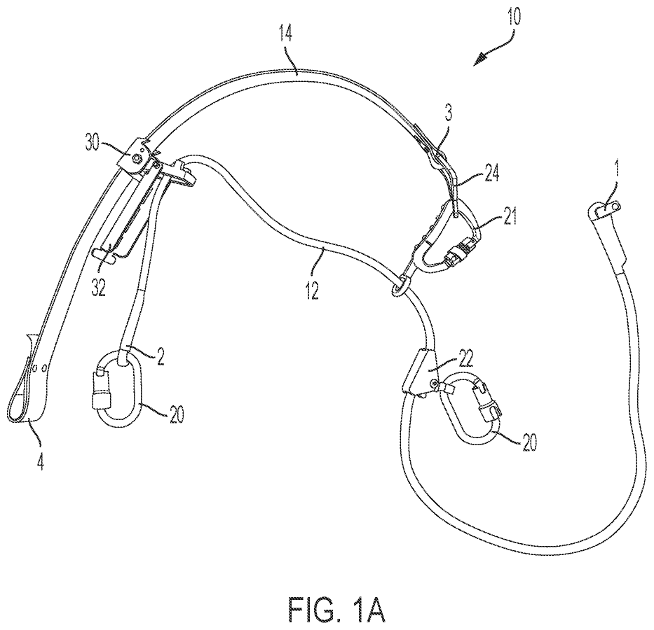

Referring now to FIGS. 1 and 1A, a perspective view of a pole climbing fall restriction assembly 10 is shown according to an embodiment. The pole climbing fall restriction assembly 10 can include an inner rope or strap 12, alternatively referred to as a positioning rope or strap, having a first end 1 and a second end 2, that can attach to the “D” rings of the work positioning belt worn by a lineman (not shown). The pole climbing fall restriction assembly 10 can include an outer strap 14, having a first end 3 and a second end 4, that can be structured and configured to encircle the outside diameter of a wooden pole (not shown) on which the lineman is working. Assembly 10 can also comprise two connectors 20 (e.g., carabineers, snap hooks, or other similar or approved connectors as should be appreciated by those of ordinary skill in the art in conjunction with a review of this disclosure) that can attach to the “D” rings of the work positioning belt worn by the lineman or pole climber. Either connector 20 can be moveable or fixed to inner rope 12, and can be attached to one end or between the ends of inner rope 12. In the depicted embodiment, one of the connectors 20 can be attached to a cam buckle or mechanism 22 and can move along the inner rope 12, and the other connector 20 can be attached and fixed to the second end 2 of inner rope 12.

Still referring to FIGS. 1 and 1A, the outer strap 14 can be attached at the first end 3 to the inner rope 12 via a connector 21 (e.g., a Roto Snap, carabineer, snap hook, or other similar connector). The outer strap 14 is also shown being attached to the inner rope via a cam assembly 30, as explained further below.

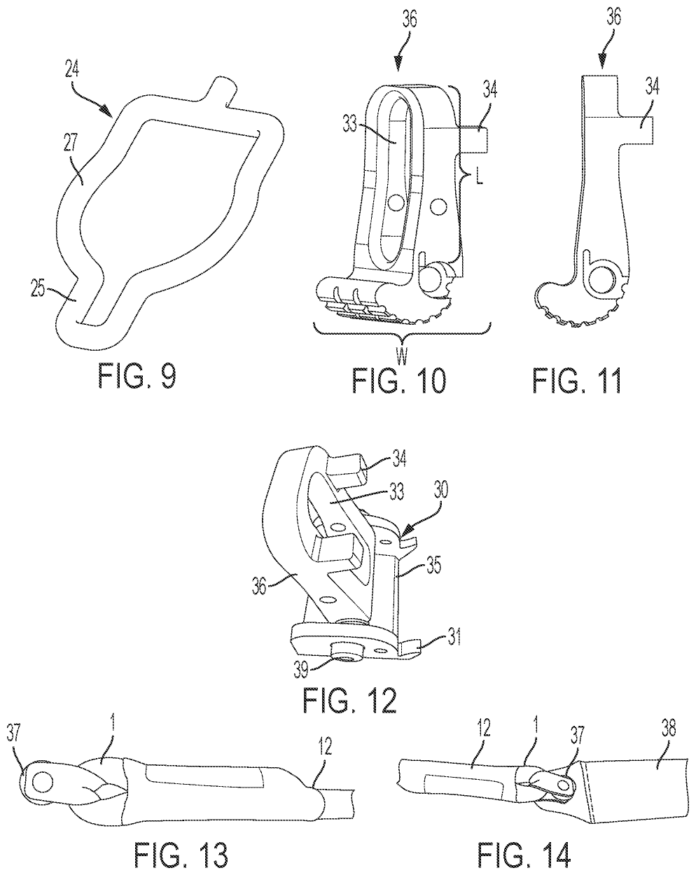

Referring now to FIG. 2, connector 21 can include a biased to close gate 29 on one side, protruding serrations 26 on the outer second side, and a first end 28 connected to the inner rope 12. Connector 21 is shown connected to nose “D” ring 24 having a large opening 27 leading to a more narrowed opening 25, as also shown in FIGS. 3 and 9. The large opening 27 allows for easy connection and disconnection, and the narrowed nose section 25 allows for a tight, firm, and safe connection during use. Connector 21 is configured so the sides of the connector, through friction or an accommodating shape, interface snuggly with the nose section 25 of the nose “D” ring 24 using friction. In one embodiment, connector 21 includes planar sides, which provides a rotational constraint of motion to the connector 21 when it is positioned in the nose section or more narrowed opening 25 of the nose “D” ring 24. In other embodiments, the shape of the narrowed opening 25 of nose “D” ring could be rectangular, oval, square, tapered, or other suitable shape, although this list is not intended to be limiting.

Referring now to FIGS. 3 and 9, nose “D” ring 24 is shown with the large opening 27 and nose section 25. In one embodiment, the nose section 25 is positioned opposite the flattened “D” portion where the strap attaches but could be positioned anywhere around the perimeter of the nose “D” ring 24 dependent on the desired interface location for connector 21 when the assembly is in use (as shown in FIG. 5). As shown in the embodiment in FIG. 3, nose “D” ring can have a square cross-section, or as shown in the embodiment in FIG. 9, nose “D” ring can have a round cross-section, although other cross-sections including oval, rectangular, or non-uniform are possible.

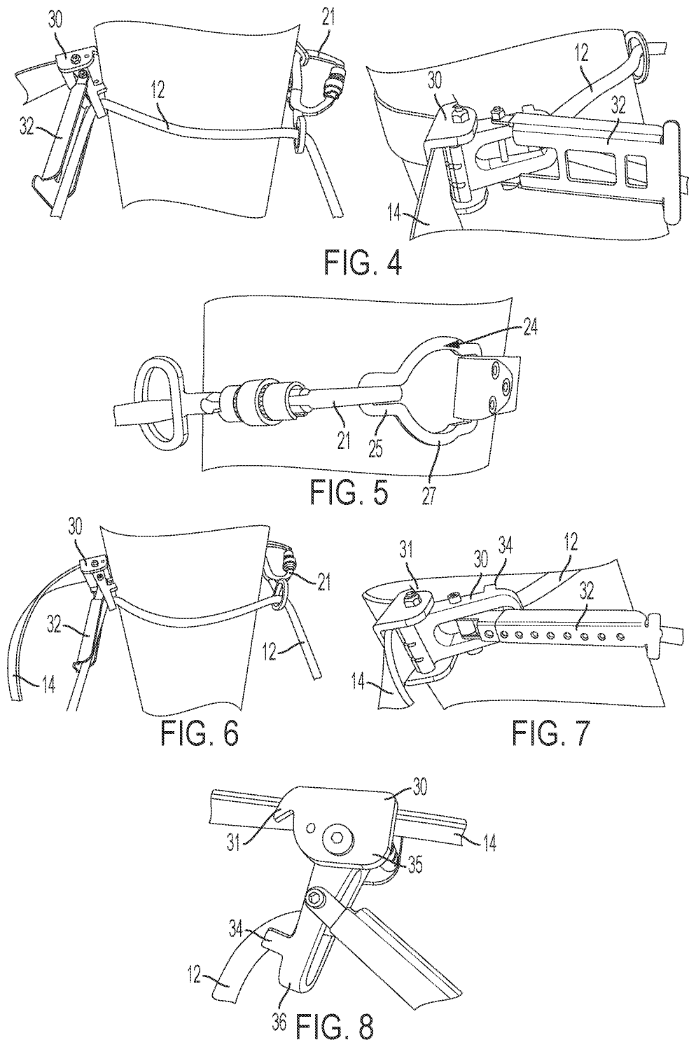

Referring now to FIG. 4, in one embodiment, outer strap 14 is operatively connected to inner rope 12 by cam assembly 30. Outer strap 14 can pass through cam assembly 30, allowing cam assembly 30 to lock onto outer strap 14 at a desired location. Cam assembly 30 can include a handle 32 for a user to grip during use.

Referring now to FIG. 5, nose “D” ring 24 is shown in use on a pole. Nose “D” ring 27 can have large opening 27 to facilitate easy connection of connector 21, and narrowed nose section 25 that can interface snuggly with connector 21 when connector 21 shifts from the large opening 27 to the nose section 25. As shown, the shape of nose section 25 can be similar to the cross-sectional shape of connector 21 so that connector 21 is constrained from rotation relative to nose “D” ring 27.

Referring now to FIG. 6, cam assembly 30 is shown in use with inner rope 12 on a pole. When cam assembly 30 is used to hold pole climbing fall restriction assembly to a pole, standoffs 34 (see FIGS. 10 and 11) keep the cam from binding the inner rope 12 against the pole.

Referring now to FIG. 7, cam assembly 30 is shown in use. As pole climbing fall restriction assembly is positioned to hold a climber on the pole, stopping teeth 31 (see FIG. 8) and standoffs 34 (see FIGS. 10 and 11) engage with the outer surface of the pole.

Referring now to FIG. 8, cam assembly 30 can comprise frame bracket 35 and cam 36. Frame bracket 35 can comprise stopping teeth 31 that can be configured to engage the pole and reduce rotation of the pole climbing fall restriction assembly around the pole while in use. In one embodiment, stopping teeth 31 are configured to substantially engage the pole only when pole climbing fall restriction assembly 10 is snug around the pole (as shown in FIGS. 6 and 7).

Referring now to FIGS. 10 and 11, cam 36 can have a pair of standoffs 34 to better hold the cam assembly 30 with respect to a pole, to keep cam assembly 30 positioned perpendicular to the pole, and to keep the inner rope 12 from binding against the pole (see FIGS. 1, 1A, 6, 7, 8, and 10-12). Cam 36 can have an elongated eye 33 through which inner rope 12 passes (as shown in FIGS. 1 and 8). In one preferred embodiment, the length L of the elongated eye 33 is at least 1.5 times greater than the width W of cam 36.

Handle 32, pivotably mounted to cam 36, may be mounted to the inside of the elongated eye 33 (as shown in FIGS. 6 and 7), or may be mounted to the exterior of cam 36 (as shown in FIGS. 1, 4, and 8).

Referring now to FIG. 12, cam assembly 30 is shown isolated from pole climbing fall restriction assembly. Pin 39 can operatively connect frame 35 to cam 36 so that cam 36 can pivot relative to frame 35. A spring can be attached to cam 36 to produce a bias force thereto relative to the frame 35 in cam assembly 30.

Referring now to FIGS. 13 and 14, a ferrous metal piece 37 can be positioned on and/or within the first end 1 of the inner rope 12, which can be used to magnetically connect to a bag 38, or other accessory, with magnets positioned therein. In one embodiment, ferrous metal piece 37 is a steel shaft with one or more washers therearound.

In order to use the pole climbing fall restriction assembly, a climber can first disconnect connector 21 from nose “D” ring 24. The climber wraps outer strap 14 around a wood pole such as an electrical pole or a tree, and then connects connector 21 with nose “D” ring 24 so that outer strap 14 and inner rope 12 are together circumscribing the pole as shown in FIGS. 4, 6, and 7. The nose “D” ring is a highly improved component over conventional devices as it enables the climber to easily connect connector 21 through large opening 27 before connector 21 engages with nose section 25 when the climber puts their weight into the unit. This uniquely provides a constrained or more rigid connection between connector 21 and nose “D” ring 24 to make it easier for the climber to climb up and down the pole. The combination of large opening 27 and nose section 25 within nose “D” ring 24 allows the climber to disconnect and reconnect quickly and without adjustment of the position of cam assembly 30 along the length of outer strap 14. When the pole climbing fall restriction assembly is positioned around the pole, the climber can then connect connectors 20 to their climbing belt or harness (not shown). The climber can use the handle 32 to overcome the spring bias force on cam 36 in order to adjust the position of outer strap 14 relative to cam assembly 30, and can also adjust the position of inner rope 12 relative to connector 21 and cam assembly 30 in order to adjust their position relative to the pole. Prior to climbing the pole or while climbing the pole, the climber can attach a magnetic accessory to the ferrous metal insert so that the climber's hand can be free for other tasks.

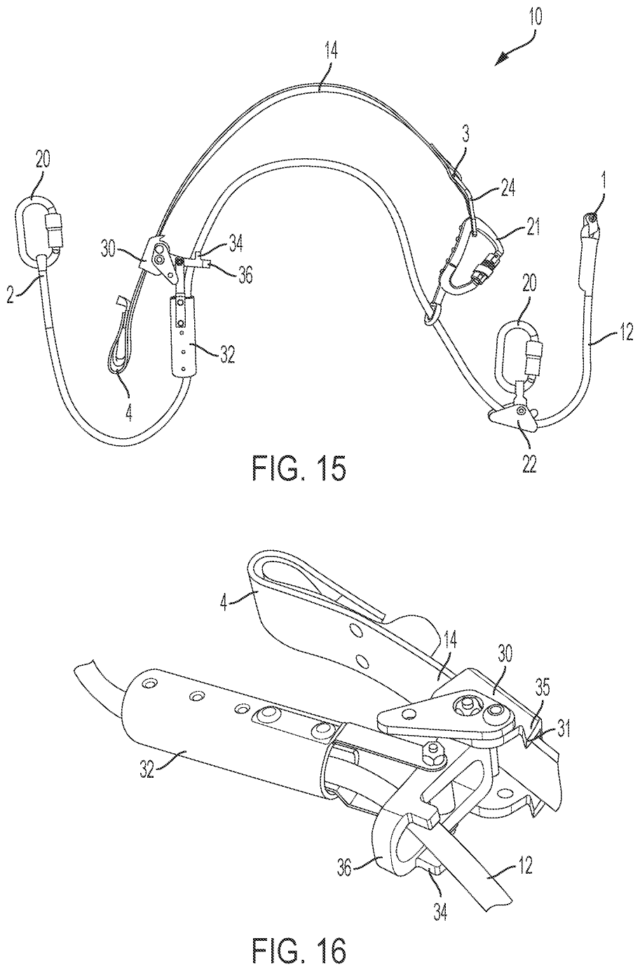

The next figures, FIGS. 15-22, describe an alternative embodiment. A main difference in this alternative embodiment includes the shape of the handle 32 (see FIG. 15). The handle 32 of this embodiment can have a cylindrical or rounded gripping surface (see FIG. 16), as compared to the prior-defined rectilinear embodiment (see FIGS. 4 and 7). The rounded gripping surface of this embodiment provides the climber with a differently shaped and potentially preferential (depending on the shape that a user prefers) secure grasp on the handle 32, enabling better control over the cam assembly 30 and safer climbing while using the pole climbing fall restriction assembly 10 (especially for those who prefer such a shape). The cylindrical or rounded handle 32 of this embodiment can have improved ergonomics for the climber to prevent fatigue or injury to their hand that can occur after using the pole climbing fall restriction assembly 10 for a prolonged period of time. The cylindrical or rounded shape of the handle 32 of this embodiment reduces harmful interference between the handle 32 and other equipment the climber is using.

Referring now to FIG. 15, the pole climbing fall restriction assembly 10 is shown according to an alternative embodiment.

Referring now to FIG. 16, the handle 32 of the present embodiment can be attached to cam 36 of cam assembly 30.

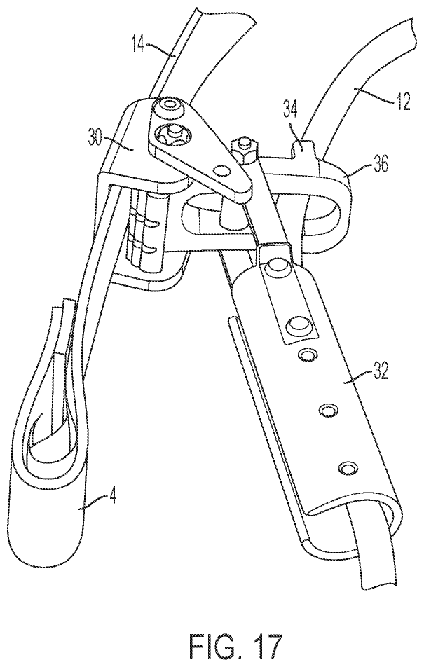

Referring now to FIG. 17, handle 32 can be round or cylindrical. The cross-section of handle 32 can be a complete circle, a portion of a circle (see FIG. 17) with a full or less than full axial slit, slot or opening (which can be, or not, connectable to form a full circle), or any other rounded profile. As depicted in FIG. 17, if handle 32 is not a complete circle, such that it is open along a portion of its profile (i.e., a slot), a portion of inner rope 12 can be positioned within handle 32 reducing the tangling of inner rope 12 with other portions of the pole climbing fall restriction assembly while in use.

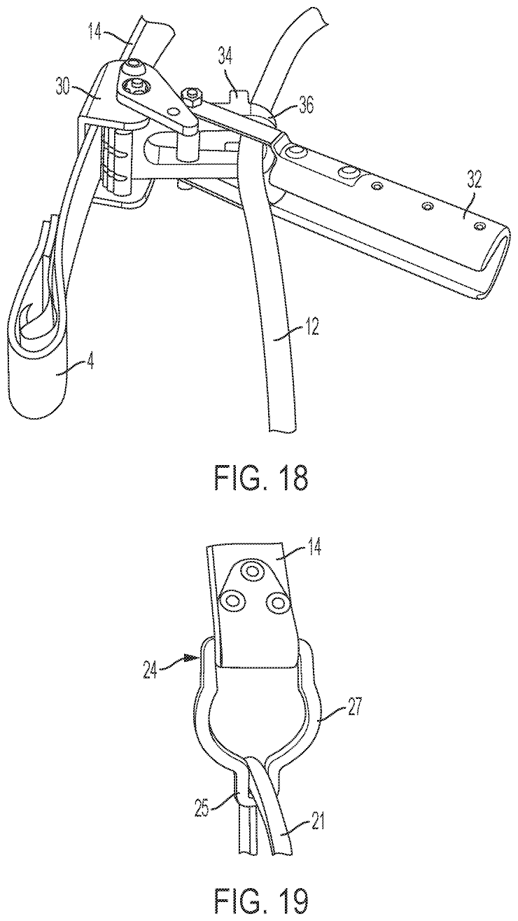

Referring now to FIG. 18, when handle 32 is configured to be open along a portion of its length, inner rope 12 can be alternately moved to be outside of the interior of handle 32.

Referring now to FIG. 19, nose “D” ring 24 is shown coupled with connector 21. Connector 21 can have parallel sides that fit within nose section 25 to prevent rotation of connector 21 relative to nose “D” ring 24.

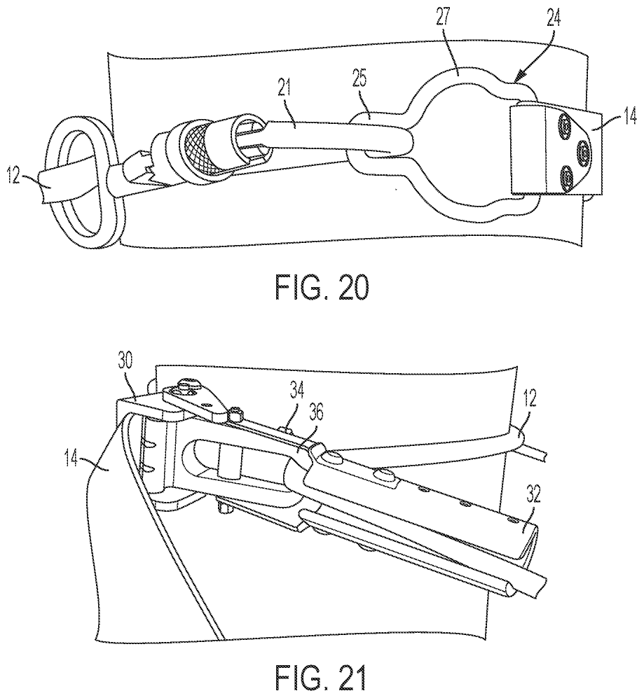

Referring now to FIG. 20, nose “D” ring 24 is shown coupled with connector 21 when the assembly is in use on a pole. As the climber uses the pole climbing fall restriction assembly, connector 21 is kept in place within the nose section 25 of nose “D” ring 24.

Referring now to FIG. 21, cam assembly 30 is shown in use on a pole. Inner rope 12 can be positioned within handle 32 to reduce the risk of inner rope 12 becoming tangled with other components of the pole climbing fall restriction assembly.

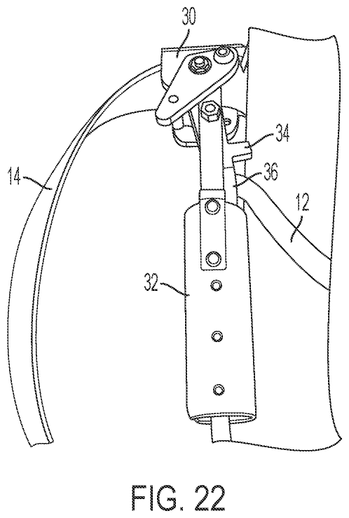

Referring now to FIG. 22, cam assembly 30 is shown in use on a pole with handle 32. When the pole climbing fall restriction assembly is snug or tight around the pole, cam assembly 30 can be configured such that stopping teeth 31 are engaged with the outer surface of the pole. The standoffs 34 of cam 36 can be configured to keep cam 36 from pinching inner rope 12 against the pole, and as shown, maintain a gap between the eyelet of cam 36 and the outer surface of the pole sufficiently large to allow the rope to slide through cam 36.

It should be understood that any of the specific dimensions recited in this application can apply to any embodiment described above. All embodiments can be combined in any way mechanically possible.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features but is not limited to possessing only those one or more features. Furthermore, a device or structure that is configured in a certain way is configured in at least that way but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. A D-ring for use with a pole climbing fall restriction assembly, comprising:
a rigid member forming a ring surrounding an eyelet; and
a straight section of the rigid member for attaching a strap, wherein the eyelet comprises a narrowed section configured to receive a connector and constrain the connector's motion relative to the D-ring.

2. A cam assembly for use with a pole climbing fall restriction assembly, the cam assembly comprising:
a frame having a base and opposing first and second sidewalls;
a cam pivotably mounted to the frame between the first and second sidewalls;
a spring coupled to the cam and producing a bias force thereto relative to the frame; and
a lever, separate from the cam, pivotably mounted to the cam and configured to assist in overcoming the bias force.

3. The cam assembly of claim 2, wherein the cam further comprises an eyelet formed through the cam.

4. The cam assembly of claim 2, further comprising:
a width of the cam between the first and second sidewalls; and
a length of the eyelet defined by a largest dimension of the eyelet, wherein the length of the eyelet is at least 1.5 times greater than the width of the cam.

5. The cam assembly of claim 2, wherein the frame further comprises a plurality of protrusions positioned to engage a surface of a pole when the pole climbing fall restriction assembly is in use.

6. The cam assembly of claim 2, wherein the cam further comprises a plurality of protrusions positioned to engage a surface of a pole when the pole climbing fall restriction assembly is in use.

7. A pole climbing fall restriction assembly, comprising:
a strap having a first end and a second end;
a connector coupled to the first end of the strap;
a D-ring coupled to the connector and comprising an opening;
a rope having a first end and a second end, wherein the rope is dimensioned to pass through the opening of the D-ring;
a cam assembly slidably positioned along the strap and the rope.

8. The pole climbing fall restriction assembly of claim 7, further comprising a metal portion positioned at at least one end of the rope.

9. The pole climbing fall restriction assembly of claim 7, further comprising an accessory magnetically coupled to the metal portion.
